(19) United States
(12) Patent Application Publication
(10) Pub. No.: US 2022/0011220 A1
(43) Pub. Date: Jan. 13, 2022

(54) LIGHT GENERATOR, CARBON ISOTOPE ANALYSIS DEVICE USING SAME, AND CARBON ISOTOPE ANALYSIS METHOD

(71) Applicants: SEKISUI MEDICAL CO., LTD., Tokyo (JP); NATIONAL UNIVERSITY CORPORATION TOKAI NATIONAL HIGHER EDUCATION AND RESEARCH SYSTEM, Aichi (JP)

(72) Inventors: Kenji YOSHIDA, Tokyo (JP); Shin-ichi NINOMIYA, Tokyo (JP); Hideki TOMITA, Aichi (JP); Tetsuo IGUCHI, Aichi (JP); Norihiko NISHIZAWA, Aichi (JP); Volker SONNENSCHEIN, Aichi (JP); Ryohei TERABAYASHI, Aichi (JP)

(73) Assignees: SEKISUI MEDICAL CO., LTD., Tokyo (JP); NATIONAL UNIVERSITY CORPORATION TOKAI NATIONAL HIGHER EDUCATION AND RESEARCH SYSTEM, Aichi (JP)

(21) Appl. No.: 17/293,660

(22) PCT Filed: Nov. 21, 2019
(86) PCT No.: PCT/JP2019/045683

§ 371 Date: May 13, 2021

(30) Foreign Application Priority Data
Nov. 21, 2018 (JP) 2018-217929
Nov. 21, 2018 (JP) 2018-217938

(51) Int. Cl. G01N 21/3504; G01N 21/01

(52) U.S. Cl. CPC G01N 21/3504; G02F 1/33; G01N 2201/067; G01N 21/01

(57) ABSTRACT

A light generator including a light source, an optical switch that controls ON/OFF of light from the light source, and a mirror that reflects light from the optical switch and sends the light back to the optical switch. A light generator less in residue in fitting of a ring-down signal, and a radioactive carbon dioxide isotope analysis device and a radioactive carbon dioxide isotope analysis method, by use of the light generator are provided.

### TECHNICAL FIELD

The present invention relates to a light generator, and a carbon isotope analysis device and a carbon isotope analysis method, by use of the light generator. In particular, the present invention relates to a light generator useful for analysis of radioactive carbon isotope ¹⁴C and the like, which is less in residue in fitting due to a decay function for determining the decay rate of a ring-down signal, and a radioactive carbon isotope analysis device and a radioactive carbon isotope analysis method, by use of the light generator.

### BACKGROUND ART

Carbon isotope analysis has been applied to a variety of fields, including assessment of environmental dynamics based on the carbon cycle, and historical and empirical research through radiocarbon dating. The natural abundances of carbon isotopes, which may vary with regional or environmental factors, are as follows: 98.89% for ¹²C (stable isotope), 1.11% for ¹³C (stable isotope), and 1×10⁻¹⁰% for ¹⁴C (radioisotope). These isotopes, which have different masses, exhibit the same chemical behavior. Thus, artificial enrichment of an isotope of low abundance and accurate analysis of the isotope can be applied to observation of a variety of reactions.

In the clinical field, in vivo administration and analysis of a compound labeled with, for example, radioactive carbon isotope ¹⁴C are very useful for assessment of drug disposition. For example, such a labeled compound is used for practical analysis in Phase I or Phase IIa of the drug development process. Administration of a compound labeled with radioactive carbon isotope ¹⁴C (hereinafter may be referred to simply as “¹⁴C”) to a human body at a very small dose (hereinafter may be referred to as “microdose”) (i.e., less than the pharmacologically active dose of the compound) and analysis of the labeled compound are expected to significantly reduce the lead time for a drug discovery process because the analysis provides findings on drug efficacy and toxicity caused by drug disposition.

Examples of the traditional ¹⁴C analysis include liquid scintillation counting (hereinafter may be referred to as “LSC”) and accelerator mass spectrometry (hereinafter may be referred to as “AMS”).

LSC involves the use of a relatively small table-top analyzer and thus enables convenient and rapid analysis. Unfortunately, LSC cannot be used in clinical trials because of its low ¹⁴C detection sensitivity (10 dpm/mL). In contrast, AMS can be used in clinical trials because of its high ¹⁴C detection sensitivity (0.001 dpm/mL), which is less than one thousandth of that of LSC. Unfortunately, the use of AMS is restricted because AMS requires a large and expensive analyzer. For example, since only around fifteens of AMS analyzers are provided in Japan, analysis of one sample requires about one week due to a long waiting time for samples to be analyzed. Thus, a demand has arisen for development of a convenient and rapid method of analyzing ¹⁴C.

Some techniques have been proposed for solving the above problems (see for example, Non-Patent Document 1 and Patent Document 1.).

I. Galli, et al. reported the analysis of ¹⁴C of a natural isotope abundance level by cavity ring-down spectroscopy (hereinafter may be referred to as “CRDS”) in Non-Patent Document 1, and this analysis has received attention.

Unfortunately, the ¹⁴C analysis by CRDS involves the use of a 4.5-μm laser source having a very intricate structure, thus, a demand has arisen for a simple and convenient apparatus or method for analyzing ¹⁴C. Thus, the present inventors have uniquely developed an optical comb light source that generates an optical comb from a single light source and thus have completed a compact and convenient carbon isotope analysis device (see Patent Document 2).

### RELATED ART

### Patent Documents

### Patent Document 1: Japanese Patent No. 3390755

### Patent Document 2: Japanese Patent No. 6004412

### Non-Patent Document

Non-Patent Document 1: I. Galli et al., Phy. Rev. Lett. 2011, 107, 270802

### SUMMARY OF INVENTION

### Technical Problem

The present inventors have made further studies in order to achieve a further enhancement in analytical accuracy of a carbon isotope analysis device, and thus have found that an error in decay rate (residue in fitting due to a decay function for determining the decay rate of a ring-down signal) is caused due to optical switch performance (ON/OFF ratio) lower than expected performance. However, there has not been found any simple and effective ON/OFF control mechanism or method.

Thus a demand has arisen for elimination of a residue in fitting of a ring-down signal and an enhancement in analytical accuracy, through an enhancement in optical switch performance (ON/OFF ratio).

An object of the present invention is to provide a light generator less in residue in fitting of a ring-down signal, and a radioactive carbon isotope analysis device and a radioactive carbon isotope analysis method, by use of the light generator.

### Solution to Problem

The present invention relates to the following aspect:

[1] A light generator including a light source, an optical switch that controls ON/OFF of light from the light source, and a mirror that reflects light from the optical switch and sends the light back to the optical switch.
[2] The light generator according to [1], wherein the optical switch is an acousto-optical modulator.
[3] The light generator according to [1] or [2], wherein the light generator includes a main light source, and a beat signal measurement system including an optical comb source that generates an optical comb made of a flux of narrow-line-width light beams where the frequency region of a light beam is 4500 nm to 4800 nm, and a photodetector that measures a beat signal generated due to the difference in frequency between light from the main light source and light from the optical comb source.
[4] A carbon isotope analysis device including a carbon dioxide isotope generator provided with a combustion unit that generates gas containing carbon dioxide isotope from carbon isotope, and a carbon dioxide isotope purifying unit; the light generator according to any one of [1] to [3]; and a spectrometer including an optical resonator and a photodetector.
[5] A carbon isotope analysis method, including the steps of: generating carbon dioxide isotope from carbon isotope; feeding the carbon dioxide isotope into an optical resonator; applying irradiation light having an absorption wavelength of the carbon dioxide isotope into the optical resonator; introducing light from a light source into an optical switch and sending light from the optical switch back to the optical switch to thereby control ON/OFF of light; measuring the intensity of the transmitted light generated by resonance of carbon dioxide isotope excited by the irradiation light; and calculating the concentration of the carbon isotope from the intensity of the transmitted light.
[6] The carbon isotope analysis method according to [5], wherein the irradiation light is applied to radioactive carbon dioxide isotope ¹⁴CO₂.
[7] The carbon isotope analysis method according to [5] or [6], including allowing a plurality of light beams to propagate through a nonlinear optical crystal to thereby generate a mid-infrared optical frequency comb of a wavelength range from 4.5 μm to 4.8 μm, as the irradiation light, due to the difference in frequency.

### Advantageous Effects of Invention

The present invention provides a light generator less in residue in fitting of a ring-down signal, and a radioactive carbon isotope analysis device and a radioactive carbon isotope analysis method, by use of the light generator.

### BRIEF DESCRIPTION OF DRAWINGS

FIG. 1 is a schematic view of a light generator.

FIG. 2 is a schematic view of the periphery of an optical switch in a light generator.

FIGS. 3A and 3B illustrate any residue in fitting due to a decay function for determining a ring-down signal acquired in a single-path and the decay rate thereof.

FIGS. 4A and 4B illustrate any residue in fitting due to a decay function for determining a ring-down signal acquired in a double-path and the decay rate thereof.

FIG. 5 illustrates the sum of squared residues in fitting to each ring-down signal, measured about a large number of such ring-down signals (variation in the sum of squared residues).

FIG. 6 is a conceptual view of a first embodiment of a carbon isotope analysis device.

FIG. 7 illustrates absorption spectra in the 4.5-μm wavelength range of ¹⁴CO₂ and contaminant gases.

FIGS. 8A and 8B illustrate the principle of high-rate scanning cavity ring-down absorption spectroscopy using laser beam.

FIG. 9 illustrates the dependence of CRDS absorption Δβ of ¹³CO₂ and ¹⁴CO₂ on temperature.

FIG. 10 is a conceptual view of a Modification of the optical resonator.

FIG. 11 is a conceptual view of a second embodiment of a carbon isotope analysis device.

FIG. 12 illustrates the relation between the absorption wavelength and the absorption intensity of an analytical sample.

FIGS. 13A, 13B and 13C each illustrate a schematic view of a second aspect of a carbon isotope analysis method.

### DESCRIPTION OF EMBODIMENTS

The present invention will now be described by way of embodiments, which should not be construed to limit the present invention. In the drawings, the same or similar reference signs are assigned to components having the same or similar functions without redundant description. It should be noted that the drawings are schematic and thus the actual dimensions of each component should be determined in view of the following description. It should be understood that the relative dimensions and ratios between the drawings may be different from each other.

<Light generator including double-path>

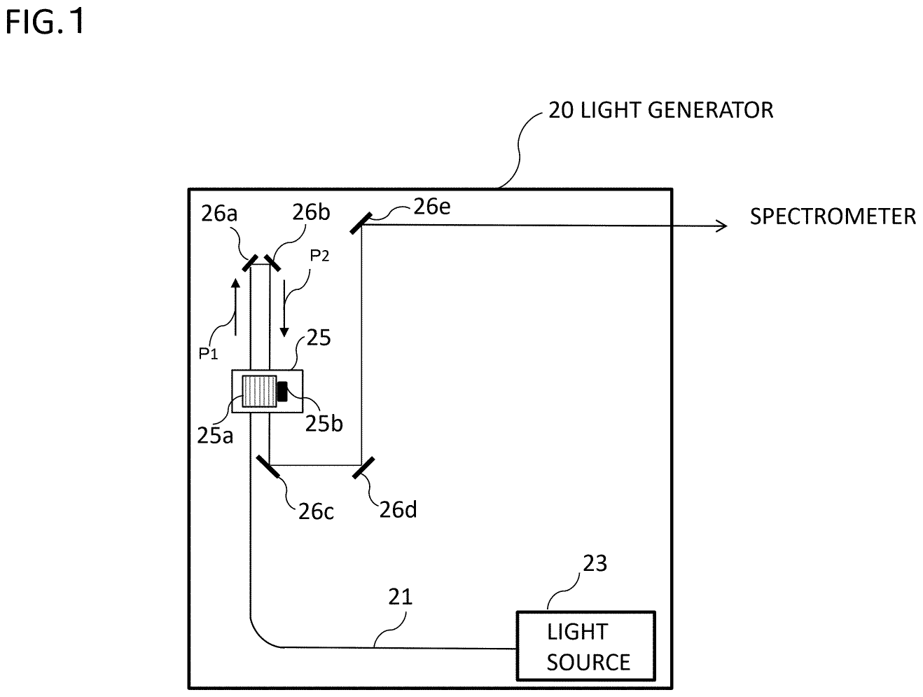

FIG. 1 is a schematic view of a light generator. A light generator 20 includes a light source 23, an optical switch 25 that controls ON/OFF of light from the light source 23, and mirrors 26a and 26b that reflect light from the optical switch 25 and send the light back to the optical switch 25. The optical path 21 is not particularly limited, and, for example, an optical fiber can be disposed therefor.

The light generator 20 further includes mirrors 26c, 26d, and 26e that introduce light from the optical switch 25 into an optical spectrometer 10A.

The light source 23 here used can be any of various light sources without particular limitation. The detail will be described later.

The optical switch 25 here used can be any of various optical switches without particular limitation, and an acousto-optical modulator (hereinafter, may be referred to as “AOM”.) is preferably used which includes an optical crystal 25a and a piezo element 25b.

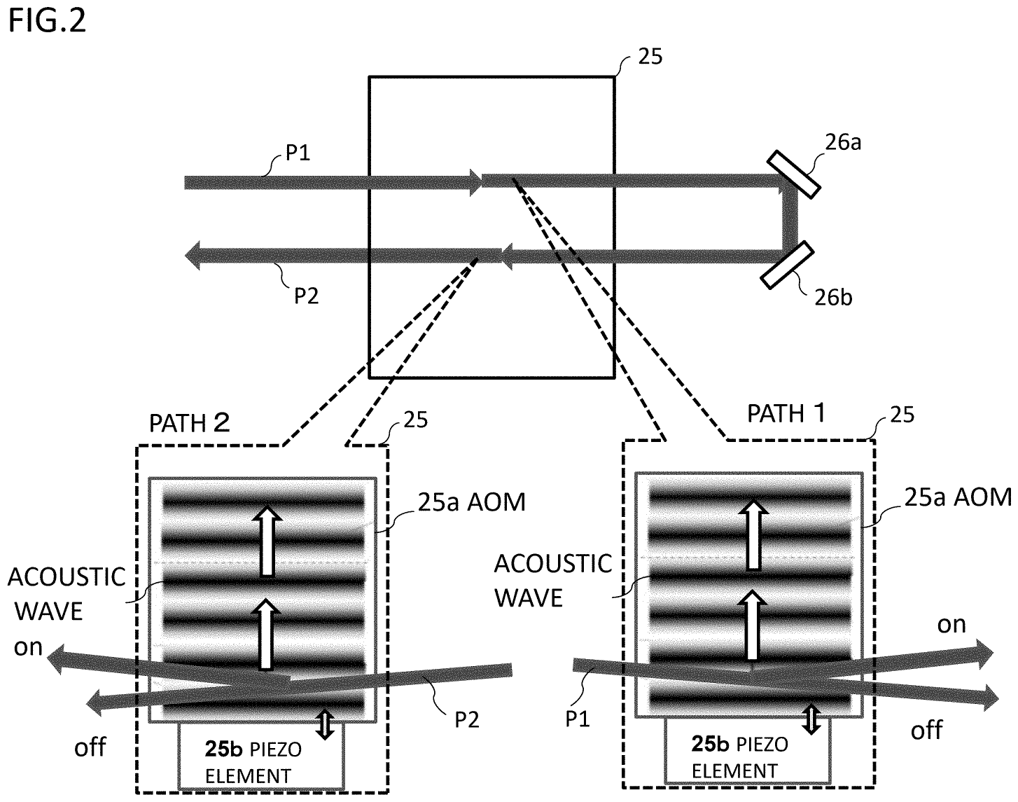

FIG. 2 is a schematic view of the periphery of an optical switch in a light generator. The piezo element 25b of the AOM is operated to allow acoustic wave to propagate in the optical crystal 25a, as indicated in a path 1 in FIG. 2. This enables a periodical refractive index distribution to occur in the optical crystal, and incident light can be diffracted to result in control of ON/OFF of light from the light source 23. However, a problem is that, even when emission of light is controlled, light which is slightly leaked out and not controlled causes an error in ring-down signal to occur. The present inventors have then completed a light generator including mirrors 26a and 26b disposed and including a double-path, in order to solve the above problems.

Next, the light generator will be described with respect to any operation and advantage thereof. (A) As indicated by a path 1 (P1) in FIG. 2, light from the light source 23 is sent to the optical switch 25, and ON/OFF control is made by use of the piezo element 25b. Thereafter, (B) light leaked out from the optical switch 25 is reflected by use of the mirrors 26a and 26b. Furthermore, (C) as indicated by a path 2 (P2) in FIG. 2, light sent back to the optical switch 25 is again subjected to ON/OFF control by use of the piezo element 25b. The light generator can thus perform ON/OFF control of light in a double-path (P1, P2), and thus obtain a much higher ON/OFF ratio than that in a single-path and be effectively prevented in leakage of light from the optical switch 25.

It is noted that, since high-rate ON/OFF control is essential for acquisition of a ring-down signal, the delay of the switching time is caused due to light passing through any position, in the case of use of the double-path. Thus, light can be allowed to pass through (P1, P2) any position at the same distance from the surfaces of the optical crystal 25a to which the piezo element 25b is attached, thereby allowing both a high ON/OFF ratio and a high-rate ON/OFF control to be satisfied.

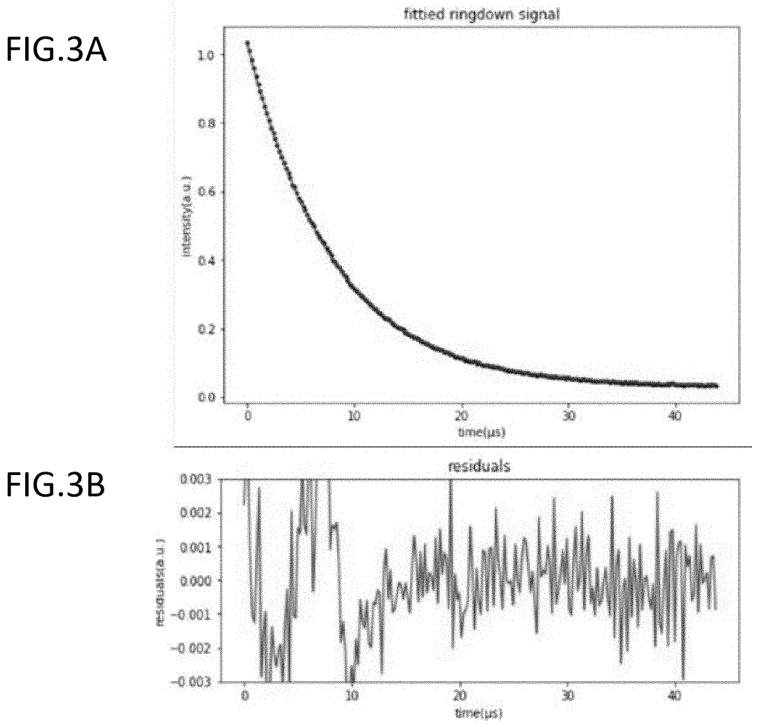

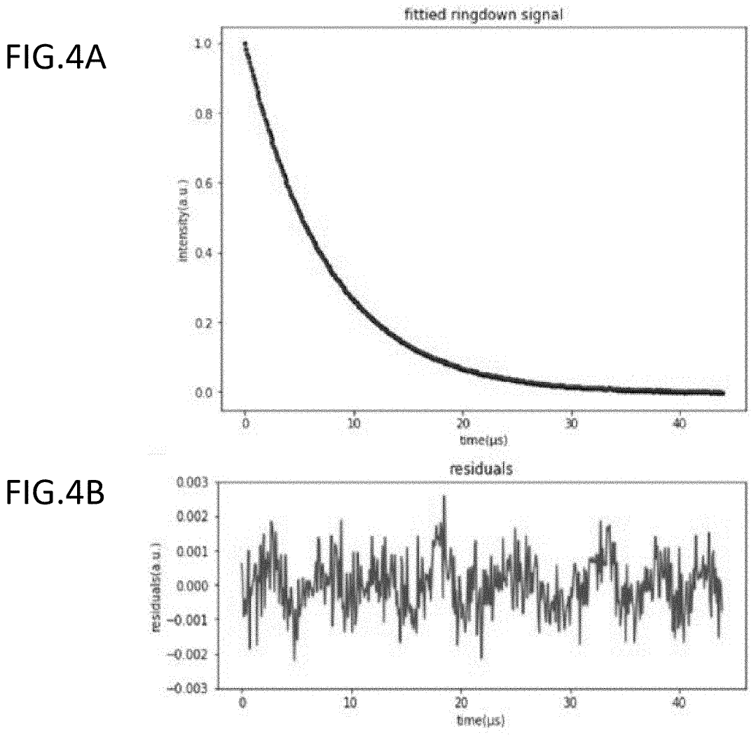

A comparison experiment between a ring-down signal acquired in the single-path and a ring-down signal acquired in the double-path was performed in order to confirm the advantages of the light generator including the double-path. Such ring-down signals were acquired by subjecting a continuous laser beam at a wavelength of 4.5 μm to ON/OFF control by the light generator, and introducing the light into an optical resonator not filled with any gas. The results obtained are illustrated in FIGS. 3 and 4.

FIG. 3 illustrates the ring-down signal acquired in the single-path, and FIG. 4 illustrates the ring-down signal acquired in the double-path. The single-path illustrated in FIG. 3 caused a broad range of vibration of residues obtained within the initial 10 μs in the ring-down signal. The double-path illustrated in FIG. 4 allowed for elimination of the problem about the range of vibration of such residues initially obtained, and allowed for a narrower variation in the range of vibration throughout the ring-down signal than that in FIG. 3.

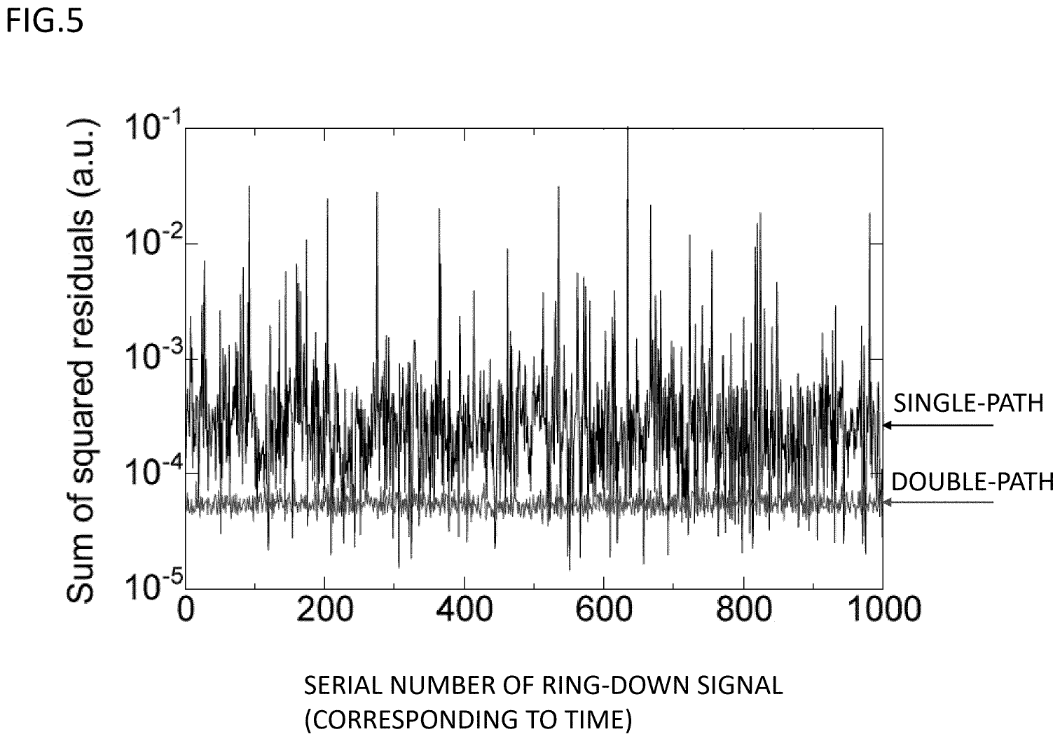

FIG. 5 illustrates the sum of squared residues in fitting to each ring-down signal, measured about a large number of such ring-down signals, namely, the variation between such residues. FIG. 5 illustrates any smaller residue with respect to the double-path in the lower drawing, than any residue with respect to the single-path in the upper drawing.

A carbon isotope analysis device using the light generator is described.

[First aspect of carbon isotope analysis device]

FIG. 1 is a conceptual view of a carbon isotope analysis device. The carbon isotope analysis device 1 includes a carbon dioxide isotope generator 40, a light generator 20A, a spectrometer 10A, and an arithmetic device 30.

A light generator 20 includes a single light source 23, a first optical fiber 21 that transmits light from the light source 23, a second optical fiber 22 that transmits light of a longer wavelength than the light from the first optical fiber 21, the second optical fiber splitting from a splitting node of the first optical fiber and coupling with the first optical fiber 21 at a coupling node downstream, a nonlinear optical crystal 24 that allows a plurality of light beams different in frequency to propagate through to thereby generate light of an absorption wavelength of the carbon dioxide isotope, from the difference in frequency, an optical switch 25 that controls ON/OFF of light from the light source 23, and mirrors 26a and 26b that reflect light from the optical switch 25 and send the light back to the optical switch 25.

The carbon dioxide isotope generator 40 includes a combustion unit that generates gas containing carbon dioxide isotope from carbon isotope, and a carbon dioxide isotope purifying unit.

The spectrometer 10 includes an optical resonator 11 having a pair of mirrors 12a, 12b, and a photodetector 15 that determines intensity of light transmitted from the optical resonator 11.

In this embodiment, a radioisotope ¹⁴C, carbon isotope will be exemplified as an analytical sample. The light having an absorption wavelength range of the carbon dioxide isotope ¹⁴CO₂ generated from the radioisotope ¹⁴C is light of a 4.5-μm wavelength range. The combined selectivity of the absorption line of the target substance, the light generator, and the optical resonator mode can achieve high sensitivity (detail is described later).

Throughout the specification, the term “carbon isotope” includes stable isotopes ¹²C and ¹³C and radioactive isotopes ¹⁴C, unless otherwise specified. In the case that the elemental signature “C” is designated, the signature indicates a carbon isotope mixture in natural abundance.

Stable isotopic oxygen includes ¹⁶O, ¹⁷O and ¹⁸O and the elemental signature “0” indicates an isotopic oxygen mixture in natural abundance.

The term “carbon dioxide isotope” includes ¹²CO₂, ¹³CO₂ and ¹⁴CO₂, unless otherwise specified. The signature “CO₂” includes carbon dioxide molecules composed of carbon isotope and isotopic oxygen each in natural abundance.

Throughout the specification, the term “biological sample” includes blood, plasma, serum, urine, feces, bile, saliva, and other body fluid and secretion; intake gas, oral gas, skin gas, and other biological gas; various organs, such as lung, heart, liver, kidney, brain, and skin, and crushed products thereof. Examples of the origin of the biological sample include all living objects, such as animals, plants, and microorganisms; preferably, mammals, preferably human beings. Examples of mammals include, but should not be limited to, human beings, monkey, mouse, rat, guinea pig, rabbit, sheep, goat, horse, cattle, pig, dog, and cat.

### <Light Generator>

The light source 23 here used can be any of various light sources without particular limitation, and is preferably an ultrashort pulse generator. In the case of use of an ultrashort pulse generator as the light source 23, a high photon density per pulse enables a nonlinear optical effect to be easily exerted, simply generating light of a 4.5-μm wavelength range corresponding to an absorption wavelength of radioactive carbon dioxide isotope ¹⁴CO₂. A flux of comb-like light beams uniform in width of each wavelength (optical frequency comb, hereinafter may be referred to as “optical comb”.) is obtained, and thus the variation in oscillation wavelength can be negligibly small. In the case of a continuous oscillation generator as the light source, the variation in oscillation wavelength causes a need for measurement of the variation in oscillation wavelength with an optical comb or the like.

The light source 23 can be, for example, a solid-state laser, a semiconductor laser or a fiber laser that generates short pulse by mode-locking. In particular, a fiber laser is preferably used because a fiber laser is a practical light source that is compact and also excellent in stability to environment.

Such a fiber laser can be an erbium (Er)-based (1.55-μm wavelength range) or ytterbium (Yb)-based (1.04-μm wavelength range) fiber laser. An Er-based fiber laser is preferably used from the viewpoint of economics, and an Yb-based fiber laser is preferably used from the viewpoint of an enhancement in intensity of light.

A plurality of optical fibers 21 and 22 can be a first optical fiber 21 that transmits light from the light source and a second optical fiber 22 for wavelength conversion, the second optical fiber splitting from the first optical fiber 21 and coupling with the first optical fiber 21 downstream. The first optical fiber 21 can be any one connected from the light source to the optical resonator. A plurality of optical components and a plurality of optical fibers can be disposed on each path of the optical fibers.

It is preferred that the first optical fiber 21 can transmit high intensity of ultrashort light pulses without deterioration of the optical properties of the pulses. Specific examples can include a dispersion-compensating fiber (DCF) and a double-clad fiber. The first optical fiber 21 should preferably be composed of fused silica.

It is preferred that the second optical fiber 22 can efficiently generate ultrashort light pulses at a desired longer wavelength and transmit high intensity of ultrashort light pulses without deterioration of the optical properties of the pulses. Specific examples can include a polarization-maintaining fiber, a single-mode fiber, a photonic crystal fiber, and a photonic bandgap fiber. The optical fiber preferably has a length of several meters to several hundred meters depending on the amount of wavelength shift. The second optical fiber 22 should preferably be composed of fused silica.

The nonlinear optical crystal 24 is appropriately selected depending on the incident light and the emitted light. In the present Example, for example, a PPMgSLT (periodically poled MgO-doped Stoichiometric Lithium Tantalate (LiTaO₃)) crystal, a PPLN (periodically poled Lithium Niobate) crystal, or a GaSe (Gallium selenide) crystal can be used from the viewpoint that light of a about 4.5-μm wavelength range is generated from each incident light. Since a single fiber laser light source is used, perturbation of optical frequency can be cancelled out in difference frequency generation as described below.

The length in the irradiation direction (longitudinal direction) of the nonlinear optical crystal 24 is preferably longer than 11 mm, more preferably 32 mm to 44 mm, because a high-power optical comb is obtained.

Difference frequency generation (hereinafter may be referred to as “DFG”) can be used to generate difference-frequency light. In detail, the light beams of different wavelengths (frequencies) from the first and second optical fibers 21 and 22 transmit through the non-linear optical crystal, to generate difference-frequency light based on the difference in frequency. In the present Example, two light beams having wavelengths λ₁ and λ₂ are generated with the single light source 23 and propagate through the nonlinear optical crystal, to generate light in the absorption wavelength of carbon dioxide isotope based on the difference in frequency. The conversion efficiency of the DFG using the nonlinear optical crystal depends on the photon density of light source having a plurality of wavelengths (λ₁, λ₂, . . . λₓ). Thus, difference-frequency light can be generated from a single pulse laser light source through DFG.

The resultant 4.5-μm wavelength range light is an optical comb composed of a spectrum of frequencies (modes) with regular intervals (fᵣ) each corresponding to one pulse (frequency f=f_{ceo}+N⋅fᵣ, N: mode number). CRDS using the optical comb requires extraction of light having the absorption wavelength of the analyte into an optical resonator including the analyte. Herein, f_{ceo} is cancelled out and thus f_{ceo} is 0 in the optical comb generated, according to a process of difference frequency generation.

In the case of the carbon isotope analysis device disclosed in Non-Patent Document 1 by I. Galli, et al., laser beams having different wavelengths are generated from two laser devices (Nd:YAG laser and external-cavity diode laser (ECDL)), and light having the absorption wavelength of the carbon dioxide isotope is generated based on the difference in frequency between these laser beams. Both such beams correspond to continuous oscillation laser beams and thus are low in intensity of ECDL, and it is thus necessary for providing DFG sufficient in intensity to place a nonlinear optical crystal for use in DFG in an optical resonator and make both such beams incident thereinto, resulting in an enhancement in photon density. It is necessary for an enhancement in intensity of ECDL to excite a Ti:Sapphire crystal by a double wave of another Nd:YAG laser to thereby amplify ECDL light. Control of resonators for performing them is required, and an increase in device size is caused and operations are complicated. In contrast, a light generator according to an embodiment of the present invention is configured from a single fiber laser light source, an optical fiber having a length of several meters, and a nonlinear optical crystal, and thus has a compact size and is easy to carry and operate. Since a plurality of light beams are generated from a single light source, these beams exhibit the same width and timing of perturbation, and thus the perturbation of optical frequency can be readily cancelled through difference frequency generation without a perturbation controller.

In some embodiments, a laser beam may be transmitted through air between the optical resonator and the coupling node of the first optical fiber with the second optical fiber. Alternatively, the optical path between the optical resonator and the coupling node may optionally be provided with an optical transmission device including an optical system for convergence and/or divergence of a laser beam through a lens.

Since an optical comb may be obtained in the present analysis within the scope where the wavelength region for analysis of ¹⁴C is covered, the present inventors have focused on the following: higher-power light is obtained with a narrower oscillation spectrum of an optical comb light source. A narrower oscillation spectrum can allow for amplification with amplifiers different in band and use of a nonlinear optical crystal long in length. The present inventors have then made studies, and as a result, have conceived that high-power irradiation light having the absorption wavelength of carbon dioxide isotope is generated based on the difference in frequency, by (A) generating a plurality of light beams different in frequency, from a single light source, (B) amplifying intensities of the plurality of light beams obtained, by use of amplifiers different in band, respectively, and (C) allowing the plurality of light beams to propagate through a nonlinear optical crystal longer in length than a conventional nonlinear optical crystal, in generation of an optical comb by use of a difference frequency generation method. The present invention has been completed based on the above finding. There has not been reported any conventional difference frequency generation method that amplifies the intensity of light with a plurality of amplifiers different in band and provides high-power irradiation light obtained by use of a crystal long in length.

Absorption of light by a light-absorbing material, in the case of a high intensity of an absorption line and also a high intensity of irradiation light, is remarkably decreased in low level corresponding to the absorption of light and appears to be saturated with respect to the effective amount of light absorption (called saturation absorption). According to a SCAR theory (Saturated Absorption CRDS), in the case where light of a 4.5-μm wavelength range, high in intensity of an absorption line, is applied to a sample such as ¹⁴CO₂ in an optical resonator, a large saturation effect is initially exhibited due to a high intensity of light accumulated in an optical resonator and a small saturation effect is subsequently exhibited due to a gradual reduction in intensity of light accumulated in an optical resonator according to progression of decay, with respect to a decay signal (ring-down signal) obtained. Thus, a decay signal where such a saturation effect is exhibited is not according to simple exponential decay. According to such a theory, fitting of a decay signal obtained in SCAR enables the decay rate of a sample and the decay rate of the back ground to be independently evaluated, and thus not only the decay rate of a sample can be determined without any influence of the variation in decay rate of the back ground, for example, due to the parasitic etalon effect, but also absorption of light by ¹⁴CO₂ can be more selectively measured due to the saturation effect of ¹⁴CO₂ larger than that of a gaseous contaminant. Accordingly, use of irradiation light higher in intensity is more expected to result in an enhancement in sensitivity of analysis. The light generator of the present invention can generate irradiation light high in intensity, and thus is expected to result in an enhancement in sensitivity of analysis in the case of use for carbon isotope analysis.

### <Carbon Dioxide Isotope Generator>

The carbon dioxide isotope generator 40 may be of any type that can convert carbon isotope to carbon dioxide isotope. The carbon dioxide isotope generator 40 should preferably have a function to oxidize a sample and to convert carbon contained in the sample to carbon dioxide.

The carbon dioxide isotope generator 40 may be a carbon dioxide generator (G) 41, for example, a total organic carbon (TOC) gas generator, a sample gas generator for gas chromatography, a sample gas generator for combustion ion chromatography, or an elemental analyzer (EA).

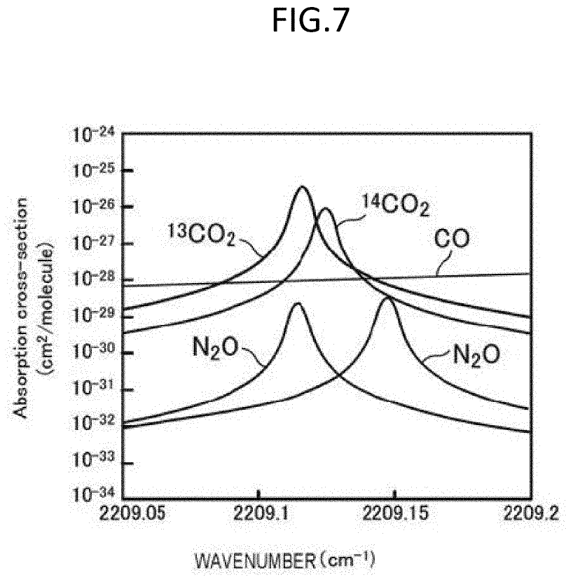

FIG. 7 is 4.5-μm wavelength range absorption spectra of ¹⁴CO₂ and competitive gases ¹³CO₂, CO, and N₂O under the condition of a CO₂ partial pressure of 20%, a CO partial pressure of 1.0×10⁻⁴% and a N₂O partial pressure of 3.0×10⁻⁸% at 273 K.

Gas containing carbon dioxide isotope ¹⁴CO₂ (hereinafter merely “¹⁴CO₂”) can be generated through combustion of a pretreated biological sample; however, gaseous contaminants, such as CO and N₂O are generated together with ¹⁴CO₂ in this process. CO and N₂O each exhibit a 4.5-μm wavelength range absorption spectrum as illustrated in FIG. 2 and interfere with the 4.5-μm wavelength range absorption spectrum assigned to ¹⁴CO₂. Thus, Co and N₂O should preferably be removed for improved analytical sensitivity.

A typical process of removing CO and N₂O involves collection and separation of ¹⁴CO₂ as described below. The process may be combined with a process of removing or reducing CO and N₂O with an oxidation catalyst or platinum catalyst.

(i) Collection and Separation of ¹⁴CO₂ by Thermal Desorption Column

The carbon dioxide isotope generator should preferably include a combustion unit and a carbon dioxide isotope purifying unit. The combustion unit should preferably include a combustion tube and a heater that enables the combustion tube to be heated. Preferably, the combustion tube is configured from refractory glass (such as quartz glass) so as to be able to accommodate a sample therein and is provided with a sample port formed on a part thereof. Besides the sample port, a carrier gas port through which carrier gas is introduced to the combustion tube may also be formed on the combustion tube. Herein, not only such an aspect where the sample port and the like are provided on a part of the combustion tube, but also a configuration where a sample introducing unit is formed as a separate component from the combustion tube at an end of the combustion tube and the sample port and the carrier gas port are formed on the sample introducing unit, may be adopted.

Examples of the heater include electric furnaces, specifically tubular electric furnaces that can place and heat a combustion tube therein. A typical example of the tubular electric furnace is ARF-30M (available from Asahi Rika Seisakusho).

The combustion tube should preferably be provided with an oxidation unit and/or a reduction unit packed with at least one catalyst, downstream of the carrier gas channel. The oxidation unit and/or the reduction unit may be provided at one end of the combustion tube or provided in the form of a separate component. Examples of the catalyst to be contained in the oxidation unit include copper oxide and a mixture of silver and cobalt oxide. The oxidation unit can be expected to oxidize H₂ and CO generated by combustion of a sample into H₂O and CO₂. Examples of the catalyst to be contained in the reduction unit include reduced copper and a platinum catalyst. The reduction unit can be expected to reduce nitrogen oxide (NOx) containing N₂O into N₂.

The carbon dioxide isotope purifying unit may be a thermal desorption column (CO₂ collecting column) of ¹⁴CO₂ in a gas generated by combustion of a biological sample, for use in gas chromatography (GC). Thus, any influence of CO and/or N₂O at the stage of detection of ¹⁴CO₂ can be reduced or removed. A CO₂ gas containing ¹⁴CO₂ iₛ temporarily collected in a GC column and thus concentration of ¹⁴CO₂ is expected. Thus, it can be expected that the partial pressure of ¹⁴CO₂ increases.

(ii) Separation of ¹⁴CO₂ through Trapping and Discharge of ¹⁴CO₂ with and from ¹⁴CO₂ Adsorbent

The carbon dioxide isotope generator 40b should preferably include a combustion unit and a carbon dioxide isotope purifying unit. The combustion unit may have a similar configuration to that described above.

The carbon dioxide isotope purifying unit may be made of any ¹⁴CO₂ adsorbent, for example, soda lime or calcium hydroxide. Thus, ¹⁴CO₂ can be isolated in the form of carbonate to thereby allow the problem of gaseous contaminants to be solved. ¹⁴CO₂ can be retained as carbonate and thus a sample can be temporarily reserved. Herein, phosphoric acid can be used in the discharge.

Such gaseous contaminants can be removed by any of or both (i) and (ii).

(iii) Concentration (Separation) of ¹⁴CO₂

¹⁴CO₂ generated by combustion of the biological sample is diffused in piping. Therefore, ¹⁴CO₂ may also be allowed to adsorb to an adsorbent and be concentrated, resulting in an enhancement in detection sensitivity (intensity). Such concentration can also be expected to separate ¹⁴CO₂ from CO and N₂O.

### <Spectrometer>

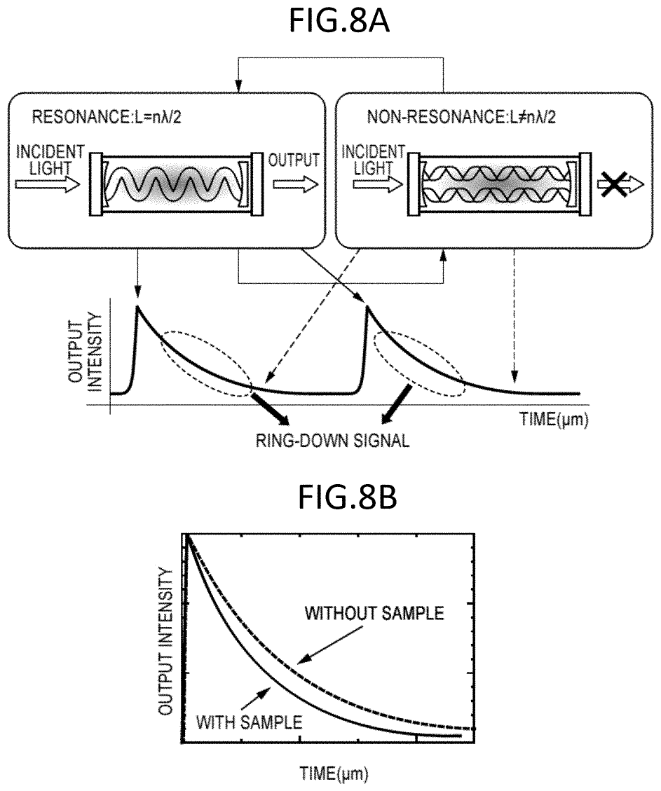

With reference to FIG. 8, the spectrometer 10A includes an optical resonator 11 and a photodetector 15 that determines the intensity of the light transmitted from the optical resonator 11. The optical resonator or optical cavity 11 includes a cylindrical body to be filled with the target carbon dioxide isotope; a pair of highly reflective mirrors 12a and 12b respectively disposed at first and second longitudinal ends of the body such that the concave faces of the mirrors confront each other; a piezoelectric element 13 disposed at the second end of the body to adjust the distance between the mirrors 12a and 12b; and a cell 16 to be filled with an analyte gas. Although not illustrated, the side of the body is preferably provided with a gas inlet through which the carbon dioxide isotope is injected and a port for adjusting the pressure in the body. Herein, the pair of mirrors 12a and 12b preferably have a reflectance of 99% or more, more preferably 99.99% or more.

A laser beam incident on and confined in the optical resonator 11 repeatedly reflects between the mirrors over several thousand to ten thousand times while the optical resonator 11 emits light at an intensity corresponding to the reflectance of the mirrors. Thus, the effective optical path length of the laser beam reaches several tens of kilometers, and a trace amount of analyte gas contained in the optical resonator can yield large absorption intensity.

FIGS. 8A and 8B illustrate the principle of high-rate scanning cavity ring-down absorption spectroscopy (hereinafter may be referred to as “CRDS”) using laser beam.

As illustrated in FIG. 8A, the optical resonator in a resonance state between the mirrors outputs a high-intensity signal. In contrast, a non-resonance state between the mirrors, by the change through operation of the piezoelectric element 13, does not enable any signal to be detected due to the interference effect of light. In other words, an exponential decay signal (ring-down signal) as illustrated in FIG. 8A can be observed through a rapid change in the length of the optical resonator from a resonance state to a non-resonance state. Such a ring-down signal may be observed by rapid shielding of the incident laser beam with an optical switch.

In the case of the absence of a light-absorbing substance in the optical resonator, the dotted curve in FIG. 8B corresponds to a time-dependent ring-down signal output from the optical resonator. In contrast, the solid curve in FIG. 8B corresponds to the case of the presence of a light-absorbing substance in the optical resonator. In this case, the light decay time is shortened because of absorption of the laser beam by the light-absorbing substance during repeated reflection of the laser beam in the optical resonator. The light decay time depends on the concentration of the light-absorbing substance in the optical resonator and the wavelength of the incident laser beam. Thus, the absolute concentration of the light-absorbing substance can be calculated based on the Beer-Lambert law ii. The concentration of the light-absorbing substance in the optical resonator may be determined through measurement of a modulation in ring-down rate, which is proportional to the concentration of the light-absorbing substance.

The transmitted light leaked from the optical resonator is detected with the photodetector, and the concentration of ¹⁴CO₂ is calculated with the arithmetic device. The concentration of ¹⁴C is then calculated from the concentration of ¹⁴CO₂.

The distance between the mirrors 12a and 12b in the optical resonator 11, the curvature radius of the mirrors 12a and 12b, and the longitudinal length and width of the body should preferably be varied depending on the absorption wavelength of the carbon dioxide isotope (i.e., analyte). The length of the resonator is adjusted from 1 mm to 10 m, for example.

In the case of carbon dioxide isotope ¹⁴CO₂, an increase in length of the resonator contributes to enhancement of the effective optical path length, but leads to an increase in volume of the gas cell, resulting in an increase in amount of a sample required for the analysis. Thus, the length of the resonator is preferably 10 cm to 60 cm. Preferably, the curvature radius of the mirrors 12a and 12b is equal to or slightly larger than the length of the resonator.

The distance between the mirrors can be adjusted by, for example, several micrometers to several tens of micrometers through the drive of the piezoelectric element 13. The distance between the mirrors can be finely adjusted by the piezoelectric element 13 for preparation of an optimal resonance state.

The mirrors 12a and 12b (i.e., a pair of concave mirrors) may be replaced with combination of a concave mirror and a planar mirror or combination of two planar mirrors that can provide a sufficient optical path.

The mirrors 12a and 12b may be composed of sapphire glass, Ca, F₂, or ZnSe.

The cell 16 to be filled with the analyte gas preferably has a small volume because even a small amount of the analyte effectively provides optical resonance. The volume of the cell 16 may be 8 mL to 1,000 mL. The cell volume can be appropriately determined depending on the amount of a ¹⁴C source to be analyzed. For example, the cell volume is preferably 80 mL to 120 mL for a ¹⁴C. source that is available in a large volume (e.g., urine), and is preferably 8 mL to 12 mL for a ¹⁴C source that is available only in a small volume (e.g., blood or tear fluid).

Evaluation of Stability Condition of Optical Resonator

The ¹⁴CO₂ absorption and the detection limit of CRDS were calculated based on spectroscopic data. Spectroscopic data on ¹²CO₂ and ¹³CO₂ were retrieved from the high-resolution transmission molecular absorption database (HITRAN), and spectroscopic data on ¹⁴CO₂ were extracted from the reference “S. Dobos, et al., Z. Naturforsch, 44a, 633-639 (1989)”.

A Modification (Δβ) in ring-down rate (exponential decay rate) caused by ¹⁴CO₂ absorption (Δβ=β−β₀ where β is a decay rate in the presence of a sample, and to is a decay rate in the absence of a sample) is represented by the following expression:

Δβ=σ₁₄(λ, T, P)N(T, P, X₁₄)c

where σ14 represents the photoabsorption cross section of ¹⁴CO₂, N represents the number density of molecules, c represents the speed of light, and σ14 and N are the function of λ (the wavelength of laser beam), T (temperature), P (pressure), and X₁₄=ratio ¹⁴C/^{Total}C.

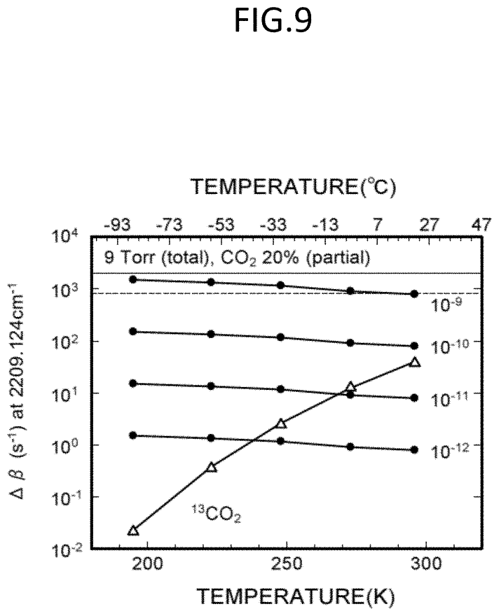

FIG. 9 illustrates the temperature dependence of calculated Δβ due to ¹³CO₂ absorption or ¹⁴CO₂ absorption. As illustrated in FIG. 9, ¹³CO₂ absorption is equal to or higher than ¹⁴CO₂ absorption at 300 K (room temperature) at a ¹⁴C/^{Total}C of 10⁻¹⁰, 10⁻¹¹, or 10⁻¹², and thus the analysis requires cooling in such a case.

If a Modification (Δβ₀) in ring-down rate (corresponding to noise derived from the optical resonator) can be reduced to a level on the order of 10¹ s⁻¹, the analysis could be performed at a ratio ¹⁴C/^{Total}C on the order of 10⁻¹¹. Thus, cooling at about −40° C. is required during the analysis.

In the case of a ratio ¹⁴C/^{Total}C of 10⁻¹¹ as a lower detection limit, the drawing suggests that requirements involve an increase (for example, 20%) in partial pressure of CO₂ gas due to concentration of the CO₂ gas and the temperature condition described above.

The cooler and the cooling temperature will be described in more detail in the section of a second aspect of the carbon isotope analysis device, described below.

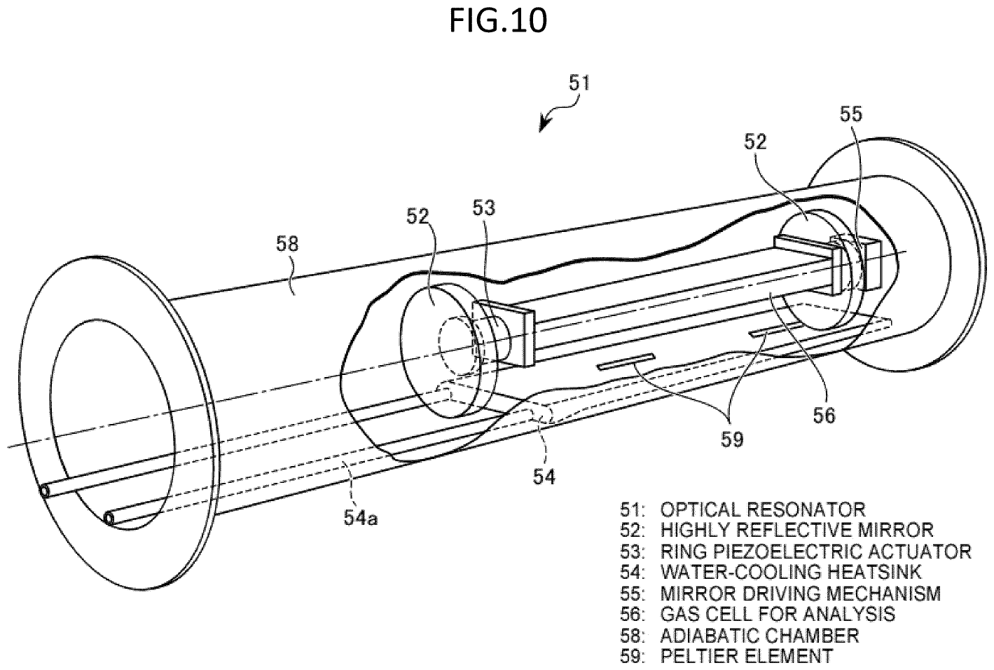

FIG. 10 illustrates a conceptual view (partially cross-sectional view) of a modification of the optical resonator 11 described. As illustrated in FIG. 10, an optical resonator 51 includes a cylindrical adiabatic chamber (vacuum device) 58, a gas cell 56 for analysis disposed in the adiabatic chamber 58, a pair of highly reflective mirrors 52 disposed at two ends of the gas cell 56, a mirror driving mechanism 55 disposed at one end of the gas cell 56, a ring piezoelectric actuator 53 disposed on the other end of the gas cell 56, a Peltier element 59 for cooling the gas cell 56, and a water-cooling heatsink 54 provided with a cooling pipe 54a connected to a circulation cooler (not illustrated).

### <Arithmetic Device>

The arithmetic device 30 may be of any type that can determine the concentration of a light-absorbing substance in the optical resonator based on the decay time and ring-down rate and calculate the concentration of the carbon isotope from the concentration of the light-absorbing substance.

The arithmetic device 30 includes an arithmetic controller 31, such as an arithmetic unit used in a common computer system (e.g., CPU); an input unit 32, such as a keyboard or a pointing device (e.g., a mouse); a display unit 33, such as an image display (e.g., a liquid crystal display or a monitor); an output unit 34, such as a printer; and a memory unit 35, such as a ROM, a RAM, or a magnetic disk.

Although the carbon isotope analysis device according to the first aspect has been described above, the configuration of the carbon isotope analysis device should not be limited to the embodiment described above, and various modifications may be made. Other aspects of the carbon isotope analysis device will now be described by focusing on modified points from the first aspect.

[Second Aspect of Carbon Isotope Analysis Device]

### <Light Generator 20B>

It has been conventionally considered that, since a quantum cascade laser (hereinafter may be referred to as “QCL”) has perturbation of oscillation wavelength and absorption wavelengths of ¹⁴C and 13C are adjacent, the QCL is difficult to use as a light source of a carbon isotope analysis device for use in ¹⁴C analysis. Thus, the present inventors have uniquely developed an optical comb light source that generates an optical comb from a single light source and thus have completed a compact and convenient carbon isotope analysis device (see Patent Document 2).

The present inventors have completed a light generator that generates narrow-line width and high-output (high-intensity) light, in order to achieve a further enhancement in analytical accuracy of a carbon isotope analysis device. The present inventors have made studies about a further application of the light generator, and as a result, have conceived that perturbation of oscillation wavelength of light generated from QCL is corrected by a beat signal measurement device where narrow-line width light generated from the light generator is used as a frequency reference. The inventors have progressively made studies based on the finding, and as a result, have completed a compact, convenient, and highly-reliable light generator where a light source other than an optical comb is adopted as a main light source, and a carbon isotope analysis device by use of the light generator.

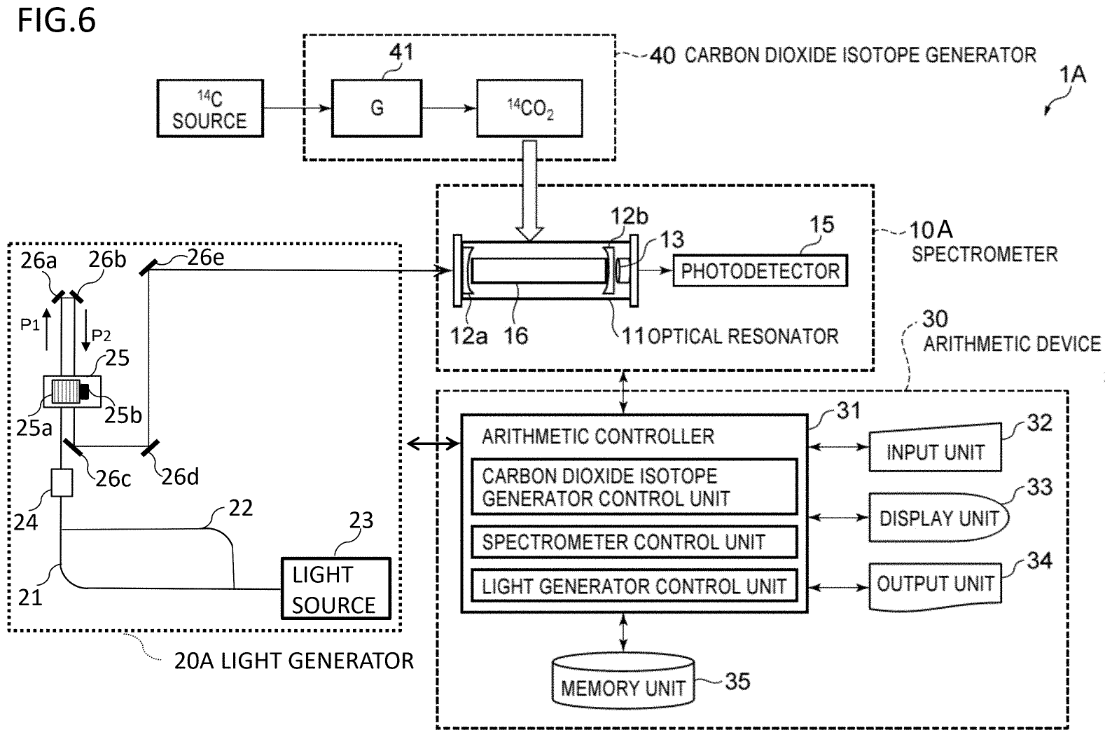

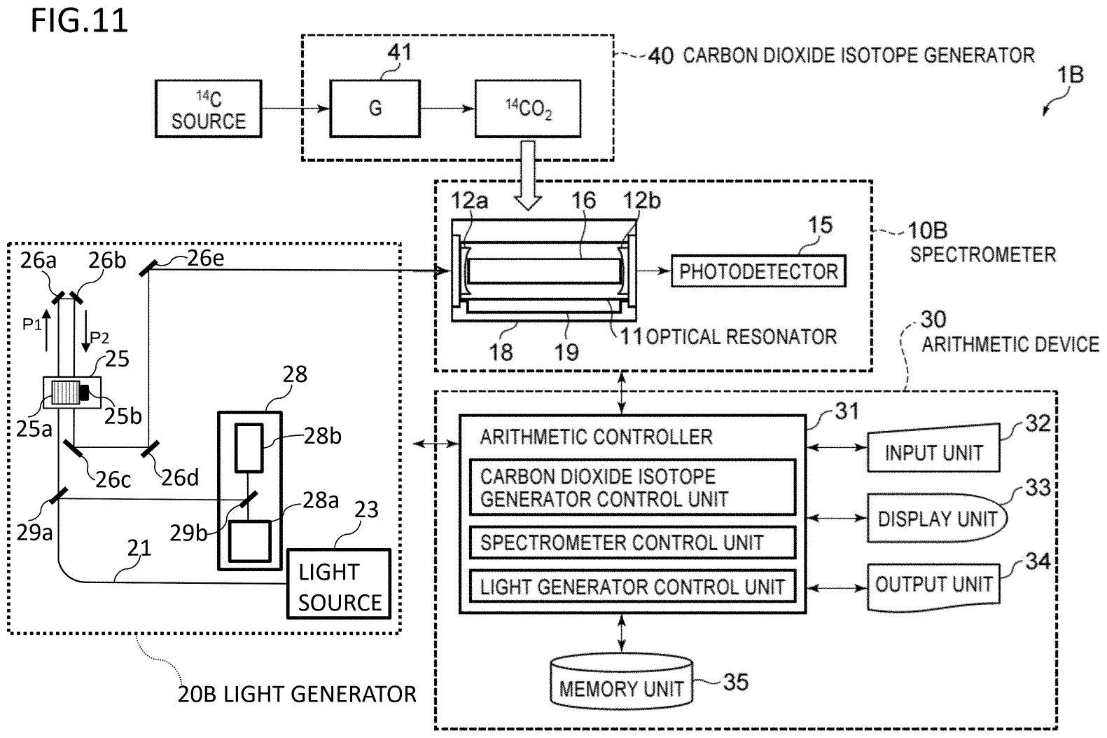

FIG. 11 schematically illustrates a carbon isotope analysis device 1B according to a second aspect. The carbon isotope analysis device 1B in FIG. 11 includes the same configuration of the light generator 20A in FIG. 6 except that the light generator 20A and the spectrometer 10A in FIG. 6 are replaced with a light generator 20B and a spectrometer 10B in FIG. 11, respectively.

The light generator 20B includes a main light source 23B and a beat signal measurement system 28.

The main light source 23B here used can be a general-purpose light source such as QCL.

The beat signal measurement system 28 includes an optical comb source 28a that generates an optical comb of a flux of narrow-line-width light beams where the frequency region of a light beam is 4500 nm to 4800 nm, and a photodetector 28b that measures a beat signal generated due to the difference in frequency between light from the main light source 23 and light from the optical comb source 28a. The optical comb source 28a here used can be the light source in the first embodiment.

The light from the main light source 23 can be partially sent into the photodetector 28b via a splitter 29a disposed on the optical fiber 21 and a splitter 29b disposed on the optical axis of light from the optical comb source 28a, and thus a beat signal can be generated due to the difference in frequency between the light from the main light source 23 and the light from the optical comb source 28a.

The main light source of the carbon isotope analysis device 1B including the light generator 20B is not limited to an optical comb, can be a general-purpose light source such as QCL, and thus is increased in flexibilities of design and maintenance of the carbon isotope analysis device 1B.

The light generator 20B may be of any type that can generate light having the absorption wavelength of the carbon dioxide isotope. In this embodiment, a compact light generator will be described that can readily generate light of a 4.5-μm wavelength range, which is the absorption wavelength of radioactive carbon dioxide isotope ¹⁴CO₂.

<Cooler and Dehumidifier>

As illustrated in FIG. 11, a spectrometer la may further include a Peltier element 19 that cools an optical resonator 11, and a vacuum device 18 that accommodates the optical resonator 11. Since the light absorption of ¹⁴CO₂ has temperature dependence, a decrease in temperature in the optical resonator 11 with the Peltier element 19 facilitates distinction between ¹⁴CO₂ absorption lines and ¹³CO₂ and ¹²CO₂ absorption lines and enhances the ¹⁴CO₂ absorption intensity. The optical resonator 11 is disposed in the vacuum device 18, and thus the optical resonator 11 is not exposed to external air, leading to a reduction in effect of the external temperature on the resonator 11 and an improvement in analytical accuracy.

The cooler for cooling the optical resonator 11 may be, for example, a liquid nitrogen vessel or a dry ice vessel besides the Peltier element 19. The Peltier element 19 is preferably used in view of a reduction in size of a spectrometer 10, whereas a liquid nitrogen vessel or a dry ice vessel is preferably used in view of a reduction in production cost of the device.

The vacuum device 18 may be of any type that can accommodate the optical resonator 11, apply irradiation light from the light generator 20 to the optical resonator 11, and transmit light transmitted, to the photodetector.

A dehumidifier may be provided. Dehumidification may be here carried out with a cooling means, such as a Peltier element, or by a membrane separation method using a polymer membrane, such as a fluorinated ion-exchange membrane, for removing moisture.

In the case that the carbon isotope analysis device 1 is used in a microdose test, the prospective detection sensitivity to the radioactive carbon isotope ¹⁴C is approximately 0.1 dpm/ml. Such a detection sensitivity “0.1 dpm/ml” requires not only use of “narrow-spectrum laser” as a light source, but also the stability of wavelength or frequency of the light source. In other words, the requirements include no deviation from the wavelength of the absorption line and a narrow line width. In this regard, the carbon isotope analysis device 1, which involves CRDS with a stable light source using “optical frequency comb light”, can solve such a problem. The carbon isotope analysis device 1 has an advantage in that the device can determine a low concentration of radioactive carbon isotope in the analyte.

The earlier literature (Hiromoto Kazuo et al., “Designing of ¹⁴C continuous monitoring based on cavity ring down spectroscopy”, preprints of Annual Meeting, the Atomic Energy Society of Japan, Mar. 19, 2010, p. 432) discloses determination of the concentration of ¹⁴C in carbon dioxide by CRDS in relation to monitoring of the concentration of spent fuel in atomic power generation. Although the signal processing using the fast Fourier transformation (FFT) disclosed in the literature has a high processing rate, the fluctuation of the baseline increases, and thus a detection sensitivity of 0.1 dpm/ml cannot be readily achieved.

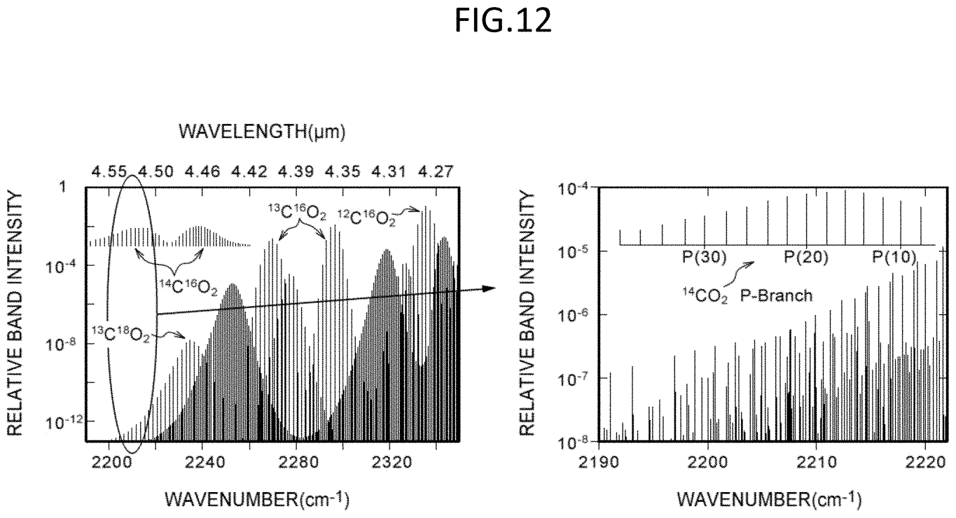

FIG. 12 (cited from Applied Physics Vol.24, pp.381-386, 1981) illustrates the relationship between the absorption wavelength and absorption intensity of analytical samples ¹²C¹⁶O₂, ¹³C¹⁸O₂, ¹³C¹⁶O₂, and ¹⁴C¹⁶O₂. As illustrated in FIG. 12, each carbon dioxide isotope has distinct absorption lines. Actual absorption lines have a finite width caused by the pressure and temperature of a sample. Thus, the pressure and temperature of a sample are preferably adjusted to atmospheric pressure or less and 273 K (0° C.) or less, respectively.

Since the absorption intensity of ¹⁴CO₂ has temperature dependence as described above, the temperature in the optical resonator 11 is preferably adjusted to a minimum possible level. In detail, the temperature in the optical resonator 11 is preferably adjusted to 273 K (0° C.) or less. The temperature may have any lower limit. In view of cooling effect and cost, the temperature in the optical resonator 11 is adjusted to preferably 173 K to 253 K (−100° C. to −20° C.), more preferably about 233 K (−40° C.)

The spectrometer may further be provided with a vibration damper. The vibration damper can prevent a perturbation in distance between the mirrors due to the external vibration, resulting in an improvement in analytical accuracy. The vibration damper may be an impact absorber (polymer gel) or a seismic isolator. The seismic isolator may be of any type that can provide the spectrometer with vibration having a phase opposite to that of the external vibration.

### [Third Aspect of Carbon Isotope Analysis Device]

The present inventors have made further studies in order to achieve a further enhancement in analytical accuracy of a carbon isotope analysis device, and thus have found that CRDS causes reflection between surfaces of an optical resonator and an optical component on an optical path, and causes a high noise on a baseline due to occurrence of the parasitic etalon effect. Thus, a demand has arisen for an optical resonator that can be suppressed in the parasitic etalon effect.

That is, the present invention also relates to a carbon isotope analysis device including a spectrometer including an optical resonator including a pair of mirrors, a photodetector that determines intensity of light transmitted from the optical resonator, and a first interference cancellation unit that adjusts a relative positional relationship between the mirrors; a carbon dioxide isotope generator provided with a combustion unit that generates gas containing carbon dioxide isotope from carbon isotope, and a carbon dioxide isotope purifying unit; and a light generator. The first interference cancellation unit here used can be an alignment mechanism which prevents interference of light on an optical axis of irradiation light applied into the optical resonator, in which one of the mirrors is mountable, and which is capable of three-dimensional position adjustment of the mirrors. The alignment mechanism here used can be a spectrometer that satisfies at least one of (i) movability in respective directions of an X-axis, a Y-axis, and a Z-axis, and (ii) rotatability in about 360 degrees around respective axes of the X-axis, the Y-axis, and the Z-axis, in a case where the optical axis of irradiation light applied into the optical resonator is defined as the X-axis. The spectrometer can further include a second interference cancellation unit. A third aspect of the carbon isotope analysis device provides an optical resonator that can be suppressed in the parasitic etalon effect, and a carbon isotope analysis device and a carbon isotope analysis method, by use of the optical resonator.

### [First Aspect of Carbon Isotope Analysis Method]

The analysis of radioisotope ¹⁴C as an example of the analyte will now be described.

### (Pretreatment of Biological Sample)

(A) Carbon isotope analysis device 1 illustrated in FIG. 1 is provided. Biological samples, such as blood, plasma, urine, feces, and bile, containing ¹⁴C are also prepared as radioisotope ¹⁴C sources.

(B) The biological sample is pretreated to remove protein and thus to remove the biological carbon source. The pretreatment of the biological sample is categorized into a step of removing carbon sources derived from biological objects and a step of removing or separating the gaseous contaminant in a broad sense. In this embodiment, the step of removing carbon sources derived from biological objects will now be mainly described.

A microdose test analyzes a biological sample, for example, blood, plasma, urine, feces, or bile containing an ultratrace amount of ¹⁴C labeled compound. Thus, the biological sample should preferably be pretreated to facilitate the analysis. Since the ratio ¹⁴C/^{Total}C of ¹⁴C to total carbon in the biological sample is one of the parameters determining the detection sensitivity in the measurement due to characteristics of the CRDS unit, it is preferred to remove the carbon source derived from the biological objects contained in the biological sample.

Examples of deproteinization include insolubilization of protein with acid or organic solvent; ultrafiltration and dialysis based on a difference in molecular size; and solid-phase extraction. As described below, deproteinization with organic solvent is preferred, which can extract the ¹⁴C labeled compound and in which the organic solvent can be readily removed after treatment.

The deproteinization with organic solvent involves addition of the organic solvent to a biological sample to insolubilize protein. The ¹⁴C labeled compound adsorbed on the protein is extracted to the organic solvent in this process. To enhance the recovery rate of the ¹⁴C labeled compound, the solution is transferred to another vessel and fresh organic solvent is added to the residue to further extract the labeled compound. The extraction operations may be repeated several times. In the case that the biological sample is feces or an organ such as lung, which cannot be homogeneously dispersed in organic solvent, the biological sample should preferably be homogenized. The insolubilized protein may be removed by centrifugal filtration or filter filtration, if necessary.

The organic solvent is then removed by evaporation to yield a dry ¹⁴C labeled compound. The carbon source derived from the organic solvent can thereby be removed. Preferred examples of the organic solvent include methanol (MeOH), ethanol (EtOH), and acetonitrile (ACN). Particularly preferred is acetonitrile.

(C) The pretreated biological sample was combusted to generate gas containing carbon dioxide isotope ¹⁴CO₂ from the radioactive isotope ¹⁴C source. N₂O and CO are then removed from the resulting gas.

(D) Moisture is preferably removed from the resultant ¹⁴CO₂. For example, moisture is preferably removed from the ¹⁴CO₂ gas in the carbon dioxide isotope generator 40 by allowing the ¹⁴CO₂ gas to pass through a desiccant (e.g., calcium carbonate) or cooling the ¹⁴CO₂ gas for moisture condensation. Formation of ice or frost on the optical resonator 11, which is caused by moisture contained in the ¹⁴CO₂ gas, may lead to a reduction in reflectance of the mirrors, resulting in low detection sensitivity. Thus, removal of moisture improves analytical accuracy. The ¹⁴CO₂ gas is preferably cooled and then introduced into the spectrometer 10 for the subsequent spectroscopic process. Introduction of the ¹⁴CO₂ gas at room temperature significantly varies the temperature of the optical resonator, resulting in a reduction in analytical accuracy.

(E) The ¹⁴CO₂ gas is fed into the optical resonator 11 having the pair of mirrors 12a and 12b as illustrated in FIG. 6. The ¹⁴CO₂ gas is preferably cooled to 273 K (0° C.) or less to enhance the absorption intensity of excitation light. The optical resonator 11 is preferably maintained under vacuum because a reduced effect of the external temperature on the optical resonator improves analytical accuracy.

(F) First light obtained from the light source 23 is transmitted through the first optical fiber 21. The first light is transmitted through the second optical fiber 22 that splits from the first optical fiber 21 and couples with the first optical fiber 21 at a coupling node downstream, thereby allowing second light of a longer wavelength than the first light to be generated from the second optical fiber 22. The intensities of the obtained first light and second light may be amplified by use of amplifiers (not illustrated) different in band, respectively.

The first optical fiber 21 of a shorter wavelength generates light of a wavelength range of 1.3 μm to 1.7 μm, and the second optical fiber 22 of a longer wavelength generates light of a wavelength range of 1.8 μm to 2.4 μm. The second light then couples with the first optical fiber 21 downstream, the first light and the second light are allowed to propagate through the nonlinear optical crystal 24, and a mid-infrared optical frequency comb of a wavelength range from 4.5 μm to 4.8 μm, as light of a 4.5-μm wavelength range corresponding to the absorption wavelength of carbon dioxide isotope ¹⁴CO₂, is generated as irradiation light, based on the difference in frequency. A long-axis crystal having a length in the longitudinal direction of longer than 11 mm can be used as the nonlinear optical crystal 24, thereby generating high-intensity light.

(G) The carbon dioxide isotope ¹⁴CO₂ is in resonance with the light. To improve analytical accuracy, the external vibration of the optical resonator 11 is preferably reduced by a vibration absorber to prevent a perturbation in distance between the mirrors 12a and 12b. During resonance, the downstream end of the first optical fiber 21 should preferably abut on the mirror 12a to prevent the light from coming into contact with air. The intensity of light transmitted from the optical resonator 11 is then determined. The light may be split and the intensity of each light obtained by such splitting may be measured.

(H) The concentration of carbon isotope ¹⁴C is calculated from the intensity of the transmitted light.

Although the carbon isotope analysis method according to the first aspect has been described above, the configuration of the carbon isotope analysis method should not be limited to the embodiment described above, and various modifications may be made. Other aspects of the carbon isotope analysis method will now be described by focusing on modified points from the first aspect.

[Second Aspect of Carbon Isotope Analysis Method]

The second aspect of the carbon isotope analysis method includes the following steps with which step (F) above is replaced.

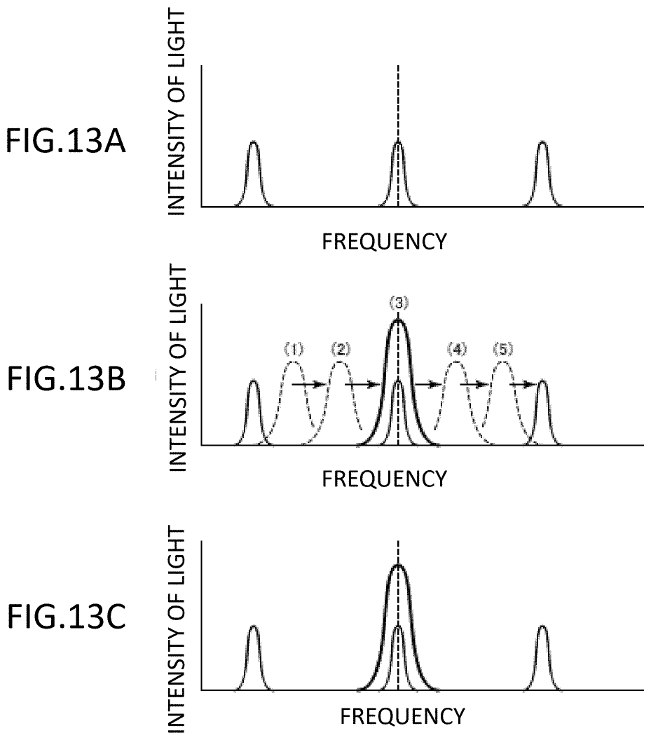

(A) The carbon isotope analysis method includes generating an optical comb made of a flux of narrow-line-width light beams where the frequency region of a light beam is 4500 nm to 4800 nm.
(B) As illustrated in FIG. 13A, a spectrum of a light beam in the optical comb is then displayed at the center of the absorption wavelength region of a test subject, in a light spectrum diagram of intensity-versus-frequency.
(C) The light from the optical comb is transmitted through the optical fiber for beat signal measurement.
(D) The light from the light source is applied to a test subject, and the amount of light absorption is measured by an optical resonator (CRDS).
(E) The light from the light source is partially split and transmitted to the optical fiber for beat signal measurement, and a beat signal is generated based on the difference in frequency between the light from the light source and the light from the optical comb source. Such a beat signal may also be generated with scanning in a wide range of frequency as in (1), (2) . . . indicated by arrows in FIG. 13B. Such a beat signal may also be generated in a desired frequency region as illustrated in FIG. 13C.
(F) Not only the amount of light absorption, obtained in step (D), but also the wavelength of light applied to the test subject, obtained by the beat signal obtained in step (E), is recorded. An accurate amount of light absorption of the test subject is measured based on such recording.

The present invention enables accurate measurement to be realized in a simple and convenient measurement system, although no phase-locking is daringly performed by an optical comb.

### OTHER EMBODIMENTS

Although the embodiment of the present invention has been described above, the descriptions and drawings as part of this disclosure should not be construed to limit the present invention. This disclosure will enable those skilled in the art to find various alternative embodiments, examples, and operational techniques.

The carbon isotope analysis device according to the embodiment has been described by focusing on the case where the analyte as a carbon isotope is radioisotope ¹⁴C. The carbon isotope analysis device can analyze stable isotopes ¹²C and ¹³C besides radioisotope ¹⁴C. In such a case, excitation light of 2 μm or 1.6 μm is preferably used in, for example, absorption line analysis of ¹²CO₂ or ¹³CO₂ based on analysis of ¹²C or ¹³C.

In the case of absorption line analysis of ¹²CO₂ or ¹³CO₂, the distance between the mirrors is preferably 10 to 60 cm, and the curvature radius of the mirrors is preferably equal to or longer than the distance therebetween.

Although the carbon isotopes ¹²C, ¹³C, and ¹⁴C exhibit the same chemical behaviors, the natural abundance of ¹⁴C (radioisotope) is lower than that of ¹²C or ¹³C (stable isotope). Artificial enrichment of the radioisotope ¹⁴C and accurate analysis of the isotope can be applied to observation of a variety of reaction mechanisms.

The light generator (optical switch) described in the first embodiment can allow for control of ON/OFF of light at a high accuracy, and thus can be utilized in various applications. For example, a measurement device, medical diagnostic device, environmental measuring device (dating system), or the like partially including the configuration described in the first embodiment can also be produced.

The optical frequency comb described in the first embodiment corresponds to a light source where longitudinal modes of a laser spectrum are arranged at equal frequency intervals at a very high accuracy, and is expected to serve as a novel, highly functional light source in the fields of precision spectroscopy and high-accuracy distance measurement. Since many absorption spectrum bands of substances are present in the mid-infrared region, it is important to develop a mid-infrared optical frequency comb light source. The optical frequency comb can be utilized in various applications other than those described in the first and second embodiments.

As described above, the present invention certainly includes, for example, various embodiments not described herein. Thus, the technological range of the present invention is defined by only claimed elements of the present invention in accordance with the proper claims through the above descriptions.

### REFERENCE SIGNS LIST

1A, 1B carbon isotope analysis device

10A, 10B spectrometer

11 optical resonator

12a, 12b mirror

13 piezoelectric element

15 photodetector

16 cell

18 vacuum device

19 Peltier element

20A, 20B light generator

21 first optical fiber

22 second optical fiber

23 light source

24 nonlinear optical crystal

25 optical switch

26a to 26e mirror

28 beat signal measurement system

29 light splitting device

30 arithmetic device

40 carbon dioxide isotope generator

1. A light generator comprising:
a light source;
an optical switch that controls ON/OFF of light from the light source; and
a mirror that reflects light from the optical switch and sends the light back to the optical switch.

2. The light generator according to claim 1, wherein the optical switch is an acousto-optical modulator.

3. The light generator according to claim 1 eft, wherein the light generator comprises:
a main light source; and
a beat signal measurement system comprising an optical comb source that generates an optical comb made of a flux of narrow-line-width light beams where the frequency region of a light beam is 4500 nm to 4800 nm, and a photodetector that measures a beat signal generated due to the difference in frequency between light from the main light source and light from the optical comb source.

4. A carbon isotope analysis device comprising:
a carbon dioxide isotope generator provided with a combustion unit that generates gas containing carbon dioxide isotope from carbon isotope, and a carbon dioxide isotope purifying unit;
the light generator according to claim 1; and
a spectrometer comprising an optical resonator and a photodetector.

5. A carbon isotope analysis method, comprising:
generating carbon dioxide isotope from carbon isotope;
feeding the carbon dioxide isotope into an optical resonator;
applying irradiation light having an absorption wavelength of the carbon dioxide isotope into the optical resonator;
introducing light from a light source into an optical switch and sending light from the optical switch back to the optical switch to thereby control ON/OFF of light;
measuring the intensity of the transmitted light generated by resonance of carbon dioxide isotope excited by the irradiation light; and
calculating the concentration of the carbon isotope from the intensity of the transmitted light.

6. The carbon isotope analysis method according to claim 5, wherein the irradiation light is applied to radioactive carbon dioxide isotope ¹⁴CO₂.

7. The carbon isotope analysis method according to claim 5, comprising allowing a plurality of light beams to propagate through a nonlinear optical crystal to thereby generate a mid-infrared optical frequency comb of a wavelength range from 4.5 μm to 4.8 μm, as the irradiation light, due to the difference in frequency.
